(19) United States
(12) Patent Application Publication
(10) Pub. No.: US 2019/0294777 A1
(43) Pub. Date: Sep. 26, 2019

(54) SYSTEMS AND METHODS FOR MANAGING ACCESS TO HOST COMPUTING DEVICES BY EXTERNAL DEVICES

(71) Applicant: Lenovo Enterprise Solutions (Singapore) Pte. Ltd., New Tech Park (SG)

(72) Inventors: Milton Cobo, Raleigh, NC (US); Eric Pettersen, Raleigh, NC (US); Matthew Nicholas Poppino, Raleigh, NC (US); Luke Remis, Raleigh, NC (US)

(21) Appl. No.: 15/935,152

(22) Filed: Mar. 26, 2018

(51) Int. Cl. G06F 21/44; G06F 13/40

(52) U.S. Cl. CPC G06F 21/44; G06F 2213/0042; G06F 13/4068

(57) ABSTRACT

Systems and methods for managing access to host computing devices by external devices are disclosed. According to an aspect, a system includes an interface to a host computing device. The system also includes a computing device controller configured to prevent access to the host computing device via the interface by an external device. The computing device controller is also configured to receive access information from the external device. Further, the computing device controller is configured to determine whether the access information is approved for permitting access to the host computing device. The computing device controller is also configured to provide access to the host computing device via the interface by the external device in response to determining that the access information is approved.

### TECHNICAL FIELD

The presently disclosed subject matter relates to computing device security and authentication. More particularly, the presently disclosed subject matter relates to systems and method for managing access to host computing devices by external devices.

### BACKGROUND

Data centers often have servers and various other computing devices that contain sensitive information. As such, preventing extraction and misuse of such sensitive data is very important. Even in instances in which extraction is authorized, the copying of such data onto an external device, such as a universal serial bus (USB) compatible device, can raise security concerns since encryption alone may be insufficient to protect such sensitive data while it is in transit. Another important concern is preventing someone from introducing, intentionally or unintentionally, harmful data into the data center using an external device.

Current solutions to these issues have included encryption as well as various software techniques to prevent the unauthorized extraction of sensitive data. However, these solutions may be prone to attack based on their implementation.

In view of the foregoing, there is a continuing need for improved systems and techniques for protecting computing devices from unauthorized extraction, misuse, or harmful data by use of an external device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for managing access to host computing devices by external devices. According to an aspect, a system includes an interface to a host computing device. The system also includes a computing device controller configured to prevent access to the host computing device via the interface by an external device. The computing device controller is also configured to receive access information from the external device. Further, the computing device controller is configured to determine whether the access information is approved for permitting access to the host computing device. The computing device controller is also configured to provide access to the host computing device via the interface by the external device in response to determining that the access information is approved.

According to another aspect, a system includes a USB interface to a host computing device. The system also includes a computing device controller configured to prevent access to the host computing device via the USB interface by an external USB compatible device. The computing device controller is configured to receive a serial number from the external USB compatible device. Further, the computing device controller is configured to determine whether the serial number is approved for permitting access to the host computing device. The computing device controller is also configured to provide access to the host computing device via the USB interface by the external USB compatible device in response to determining that the serial number is approved.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings example embodiments; however, the presently disclosed subject matter is not limited to the specific methods and instrumentalities disclosed. In the drawings:

FIG. 1 is a block diagram of an example system for managing access to a host computing device by an external device;

FIG. 2 is a flow chart of an example method for managing access to a host computing device by an external device in accordance with embodiments of the present disclosure; and

FIG. 3 is a flow chart of another example method for managing access to a host computing device by an external device in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

Systems and methods according to the present disclosure can provide protection to computing devices from unauthorized extraction, misuse, or harmful data by use of an external device. For example, systems and methods described herein may be utilized for protecting servers in data centers from unauthorized extraction, misuse, or harmful data by use of USB compatible device.

As referred to herein, a “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, a server. In another example, a computing device may be any type of conventional computer, such as a laptop computer or a tablet computer or a desktop computer. In another example, the computing device may be a type of network device such as a router or a switch. In another example, the computing device may be a smart television or a high definition television. In another example, the computing device may be a battery powered Internet of Things (IoT) device. Although many of the examples provided herein are implemented on servers in a data center, the examples may similarly be implemented on any suitable computing device or computing devices.

As referred to herein, a server may be any suitable computing device that provides functionality for other computing devices or programs, referred to as “clients”. A single server may serve multiple clients, and a single client can use multiple servers. Multiple servers may operate in a data center, which is a facility that houses the servers and associated electronic components, such as telecommunication and storage systems.

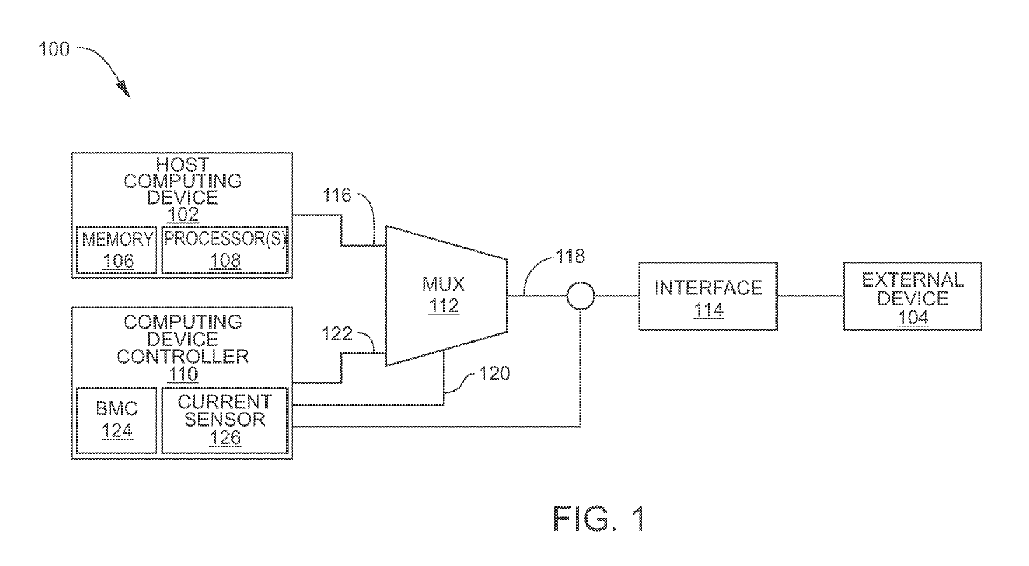

In accordance with the embodiments, FIG. 1 illustrates a block diagram of an example system 100 for managing access to a host computing device 102 by an external device 104. The host computing device 102 is described in this example as being a server operating within a data center. The host computing device 102 may include memory 106 on which sensitive information may be stored. The host computing device 102 may include one or more processors 108 configured to manage and implement functionality as requested by clients. The host computing device 102 may be operable with a computing device controller 110, a multiplexer (MUX) 112, and an interface 114. The computing device controller 110, MUX 112, and interface 114 may be integrated with the computing device 102, or operate as separate components.

The interface 114 may be configured to operably connect the host computing device 102 to the external device 104. For example, the external device 104 may be “plugged into” or physically connected to the interface 114 such that the host computing device 102 and the external device 104 may communicate with one another for the exchange of data. Data may be exchanged between the host computing device 102 and the external device 104 via the data lines 116 and 118 connecting the host computing device 102, MUX 112, and the interface 114 to each other.

In an example, the external device 104 is a USB compatible device, and the interface 114 is a USB compatible interface. Example external devices include, but are not limited to, keyboards, mice, flash drives, hard drives, and the like. Alternative, the external device 104 may be any other suitable type of external device operable with a computing device, and the interface 114 may be operable to interface with the external device.

The computing device controller 110 may be configured to prevent access to the host computing device 102 by the external device 104. For example, the computing device controller 110 may be operably connected to the MUX 112 via a select line 120. In this example, the external device 104 may be communicatively connected to the host computing device 102 via the MUX 112 and the interface 114. The computing device controller 110 may input a control signal to the MUX 112 for preventing access to the host computing device 102 by the external device 104. Conversely, the computing device controller 110 may input a control signal into the MUX 112 to enable access to the host computing device 102 by the external device 104. It is noted that in this example a MUX is utilized as a controllable electronic device to enable or prevent communication of the between the host computing device 102 and the external device 104, but it should be recognized that any other suitable device may be used.

The computing device controller 110 may be configured to receive access information from the external device 104. Further, the computing device controller 110 may be configured to determine whether the access information is approved for permitting access to the host computing device 102, and to provide access to the host computing device 102 by the external device 104 in response to determining that the access information is approved. For example, when the external device 104 is physically connected to the interface 114, the computing device controller 110 may input a control signal into the MUX 112 to enable the external device 104 to transfer its access information to the computing device controller 110. Data may be communicated between the computing device controller 110 and the external device 104 via the data lines 118 and 122 that the computing device controller 110, MUX 112, and the interface 114 to each other. As described in more detail herein, the computing device controller 110 may either prevent or provide access of the external device 104 to the host computing device 102 based on the access information provided by the external device 104.

Example access information includes, but is not limited to, an identifier of an external device, power consumption information of the external device, type information of the external device. An identifier may be a serial number of the external device. Power consumption information may indicate how much power the external device utilizes during operation. Type information of the external device may be, for example, information indicating a model of the external device.

The computing device controller 110 may include a baseboard management controller (BMC) 124 and/or any other suitable electronic components for implementing the functionality of the computing device controller 110 described herein. The BMC 124 and/or other components may be part of the host computing device 102. In an example, the computing device controller 110 may include hardware, software, firmware or combinations thereof for implementing the functionality described herein.

The computing device controller 110 may include a sensor 126 operatively connected to data line 118 or another part of interface 114 for detecting whether the external device 104 is connected to or not connected to the interface 114. For example, the sensor 126 may be a current sensor operable to detect the connection and to indicate the detection to the BMC 124. In another example, a physical presence pin may be used to detect the plug-in or removal of an external device. The BMC 124 may prevent access to the host computing device 102 via the interface 114 in response to detecting an external device is not connected to the interface 104.

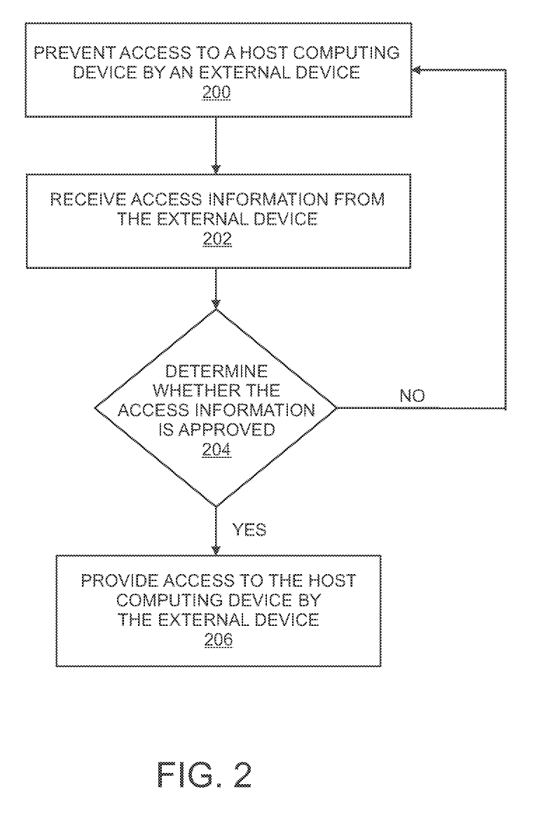

FIG. 2 illustrates a flow chart of an example method for managing access to a host computing device by an external device in accordance with embodiments of the present disclosure. The method is described by example as being implemented by the system 100 shown in FIG. 1, although it should be understood that the method may alternatively be implemented by any other suitable system.

Referring to FIG. 2, the method includes preventing 200 access to a host computing device by an external device. With reference to the example of FIG. 1, when the external device 104 is plugged into the interface 114 shown in FIG. 1, the computing device controller 110 can detect the physical connection and prevent access to the host computing device 102 by control of MUX 112.

The method of FIG. 2 includes receiving 202 access information from the external device. With continuing reference to the aforementioned example, the computing device controller 110 can receive access information from the external device 104. For example, the external device 104 may store authentication information such as its identifier (e.g., its serial number or model number). The computing device controller 110 can retrieve the information via control of the MUX 112.

The method of FIG. 2 includes determining 204 whether the access information is approved for permitting access to the host computing device. With continuing reference to the aforementioned example, the computing device controller 110 may maintain a list of identifiers approved for permitting access to the host computing device 102. The computing device controller 110 may also determine whether the identifier received from the external device 104 matches any one of the approved identifiers. The computing device controller 110 may approve access if it determines that the received identifier matches any one of the approved identifier. More generally, the computing device controller 110 may maintain or store any suitable list of information for comparison to access information received from the external device 104 for determining whether access is permitted.

The method of FIG. 2 includes providing 206 access to the host computing device by the external device in response to determining that the access information is approved. With continuing reference to the aforementioned example, the computing device controller 110 may control the MUX 112 to communicatively connect the external device 104 to the host computing device 102 in response to determining that the access information is approved. For example, the computing device controller 110 may transmit a control signal on select line 120 for controlling the MUX 112 to communicatively connect host computing device 102 and the external device 104.

In response to determining 204 that the access information is not approved, the access is prevented at step 200. With continuing reference to the aforementioned example, the computing device controller 110 may control the MUX 112 to prevent communicative connection of external device 104 to the host computing device 102 in response to determining that the access information is not approved. For example, the computing device controller 110 may transmit a control signal on select line 120 for controlling the MUX 112 to communicatively disconnect the connection between the host computing device 102 and the external device 104.

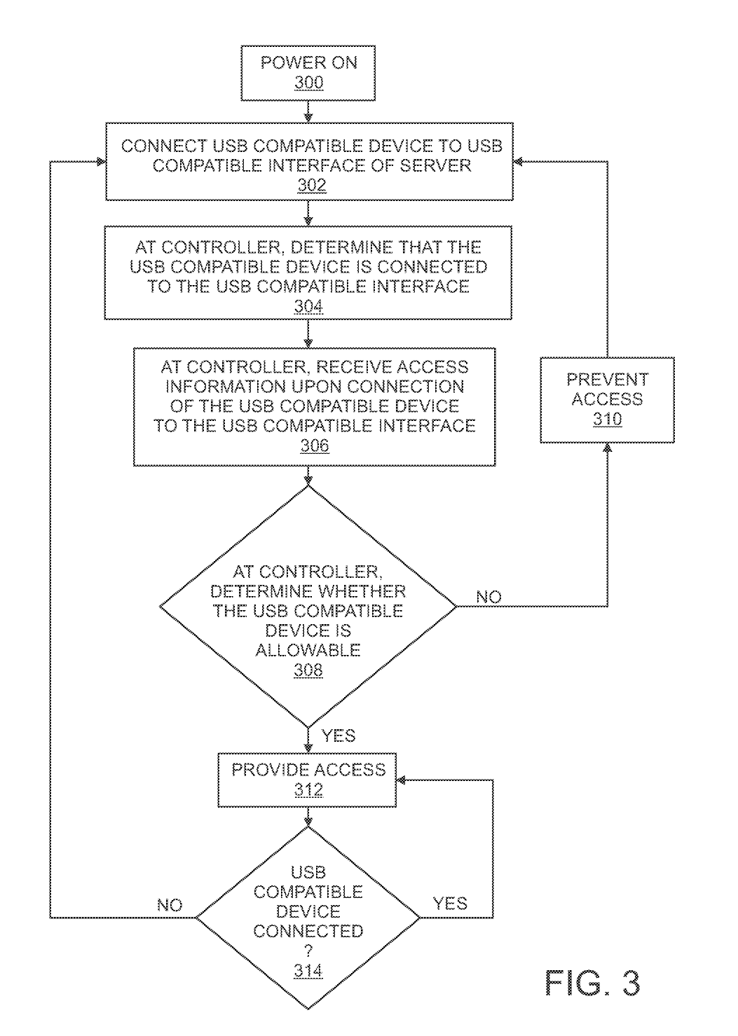

FIG. 3 illustrates a flow chart of another example method for managing access to a host computing device by an external device in accordance with embodiments of the present disclosure. The method is described by example as being implemented by the system 100 shown in FIG. 1, although it should be understood that the method may alternatively be implemented by any other suitable system.

Referring to FIG. 3, the method includes powering on 300 a system for managing access to a host computing device by an external device. For example, the system 100 of FIG. 1 may be powered on. More particularly, the computing device controller 110 can be powered on. The host computing device 102 may be a server that is powered on.

The method of FIG. 3 includes connecting 302 a USB compatible device to a USB compatible interface of a server. Continuing the aforementioned example, the external device 104 may be physically connected to the interface 114 for operation of the external device 104 with the interface 114. In this example, the external device 104 is a USB compatible device, and the interface 114 is a USB compatible interface.

The method of FIG. 3 includes determining 304, at a computing device controller, that the USB compatible device is connected to the USB compatible interface. Continuing the aforementioned example, the BMC 124 may determine that the USB compatible device is connected to the USB compatible interface. In an example, the sensor 126 may be operatively connected to the data line 118 for detecting whether there is current draw on the data line 118. The method of FIG. 3 also includes receiving 306, at the computing device controller, access information upon connection of the USB compatible device to the USB compatible interface. Continuing the aforementioned example, the BMC 124 may control the MUX 112 for obtaining access information from the external device 104.

The method of FIG. 3 includes determining 308, at the computing device controller, whether the USB compatible device is allowable. Continuing the aforementioned example, the BMC 124 can determine whether the USB compatible device is allowable. More particularly, the BMC 124 can determine whether the USB compatible device is allowable. In an example, the BMC 124 may store a white list of keys, and may compare a drive serial number from the USB compatible device to the white list to determine whether there is a match.

If it is determined that the USB compatible device is not allowable at block 308, access is prevented (step 310). For example, the BMC 124 can control the MUX 112 to prevent the access of the USB compatible device to the host computing device 102. Subsequently, the method may proceed to block 302 when a USB compatible device is connected to the USB compatible interface.

Conversely, if it is determined that the USB compatible device is allowable at block 308, access is provided to the USB compatible device (step 312). For example, the BMC 124 can control the MUX 112 to provide access of the USB compatible device to the host computing device 102. Subsequently, the method may proceed to block 314.

At block 314, the method includes determining whether the USB compatible device is connected. Continuing the aforementioned example, the BMC 124 can determine whether the USB compatible device is connected. Particularly, the BMC 124 may sense whether there is a current draw on data line 118 for deducing whether the USB compatible device is connected. In response to determining that the USB compatible device is connected, access may continue to be provided at step 312. Conversely, in response to determining that the USB compatible device is not connected, the method may proceed to step 302 for receiving connection of another USB compatible device or for re-connection of the same USB compatible device.

In accordance with embodiments, a computing device controller can control access of an external device to a host computing device based on a battery profile of the external device and/or power consumption of the host computing device, such as with power critical applications.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
preventing access to a host computing device by an external device;
receiving access information from the external device;
determining whether the access information is approved for permitting access to the host computing device; and
in response to determining that the access information is approved, providing access to the host computing device by the external device.

2. The method of claim 1, wherein the host computing device is a server.

3. The method of claim 1, wherein the external device is a universal serial bus (USB) compatible device.

4. The method of claim 1, wherein the access information comprises at least one of an identifier of the external device, power consumption information of the external device, and a type of the external device.

5. The method of claim 1, further comprising determining that the external device is physically-interfaced with an interface of the host computing device, and
wherein receiving access information comprising receiving access information upon physical interface of the external device with the interface of the host computing device.

6. The method of claim 1, wherein receiving access information comprises receiving an identifier of the external device, and
wherein determining whether the access information is approved comprises determining whether the identifier of the external device is approved for permitting access by the external device to the host computing device.

7. The method of claim 6, further comprising maintaining a list of identifiers approved for permitting access to the host computing device, and
wherein determining whether the access information is approved comprises:
determining whether the identifier received from the external device matches one of the approved identifiers; and
permitting the access in response to determining that the received identifier matches one of the approved identifiers.

8. The method of claim 1, wherein preventing access to the host computing device comprises preventing access to the host computing device by the external device in response to determining that the access information is not approved.

9. The method of claim 1, wherein the host computing device comprises an interface for external devices, and
wherein the method further comprises detecting whether the external device is not connected to the interface, and
wherein preventing access to the host computing device comprises preventing access to the host computing device via the interface in response to detecting that the external device is not connected to the interface.

10. A system comprising:
an interface to a host computing device;
a computing device controller configured to:
prevent access to the host computing device via the interface by an external device;
receive access information from the external device;
determine whether the access information is approved for permitting access to the host computing device; and
provide access to the host computing device via the interface by the external device in response to determining that the access information is approved.

11. The system of claim 10, wherein the host computing device is a server.

12. The system of claim 10, wherein the external device is a universal serial bus (USB) compatible device.

13. The system of claim 10, wherein the access information comprises at least one of an identifier of the external device, power consumption information of the external device, and a type of the external device.

14. The system of claim 10, wherein the computing device controller comprises a baseboard management controller (BMC).

15. The system of claim 10, wherein the interface comprises a multiplexer configured to be controller by the computing device controller to:
prevent the access to the host computing device;
controllably connect the external device to the host computing device;
receive the access information from the external device; and
communicate the access information to the computing device controller.

16. The system of claim 10, wherein the computing device controller is configured to:
determine that the external device is physically-interfaced with the interface of the host computing device; and
receive access information upon physical interface of the external device with the interface of the host computing device.

17. The system of claim 10, wherein the computing device controller is configured to:
receive an identifier of the external device, and
determine whether the identifier of the external device is approved for permitting access by the external device to the host computing device.

18. The system of claim 17, wherein the computing device controller is configured to:
maintain a list of identifiers approved for permitting access to the host computing device;
determine whether the identifier received from the external device matches one of the approved identifiers; and
permit the access in response to determining that the received identifier matches one of the approved identifiers.

19. The system of claim 10, wherein the computing device controller is configured to:
use a sensor to detect whether the external device is not connected to the interface, and
prevent access to the host computing device via the interface in response to detecting that the external device is not connected to the interface.

20. A system comprising:
a universal serial bus (USB) interface to a host computing device;
a computing device controller configured to:
prevent access to the host computing device via the USB interface by an external USB compatible device;
receive a serial number from the external USB compatible device;
determine whether the serial number is approved for permitting access to the host computing device; and
provide access to the host computing device via the USB interface by the external USB compatible device in response to determining that the serial number is approved.
